(19) United States
(12) Patent Application Publication
(10) Pub. No.: US 2026/0326297 A1
(43) Pub. Date: Oct. 22, 2026

(54) Method and System for Parameterizing a Controller for a Robot Process

(71) Applicant: KUKA Deutschland GmbH, Augsburg (DE)

(72) Inventors: Bernhard Haas, Augsburg (DE); Franz Pecher, Augsburg (DE); Sascha Baum, Augsburg (DE); Karsten Monreal, Augsburg (DE)

(73) Assignee: KUKA Deutschland GmbH, Augsburg (DE)

(21) Appl. No.: 19/647,288

(22) Filed: Apr. 14, 2026

(30) Foreign Application Priority Data
Apr. 17, 2025 (DE) 102025115297

(51) Int. Cl. B25J 9/16

(52) U.S. Cl. CPC B25J 9/1671; B25J 9/163

(57) ABSTRACT

A method for parameterizing a controller for a robot process includes providing a first time profile of a first state variable of the robot process for a first value of a first controller parameter of the controller providing at least one further time profile of the first state variable for a different value of the first controller parameter; ascertaining quality values for the time profiles by data processing based at least in part on machine learning; and optimizing the value of the first controller parameter with an optimizer based on the values of the first controller parameter and the quality values ascertained for the time profiles.

### CROSS-REFERENCE TO RELATED APPLICATIONS

This application claims the benefit of priority under 35 U.S.C. § 119(a) to German Patent Application No. DE 10 2025 115 297.7, filed Apr. 17, 2025, the disclosure of which is incorporated by reference herein in its entirety.

### TECHNICAL FIELD

The present invention relates, in particular, to a method and system for parameterizing a controller for a robot process, and to a computer program or computer program product for carrying out the method.

### BACKGROUND

Controllers for robot processes have generally been parameterized manually in practice, which is labor-intensive, not very reproducible, and requires experienced skilled personnel.

### SUMMARY

The object of the present invention is to improve the parameterization of a controller for a robot process and/or the performance of the robot process.

This object is achieved by a method, a system, and a computer program or computer program product for carrying out a method as described herein.

According to one embodiment of the present invention, a method for parameterizing or specifying parameters of a controller (“controller parameters”) for a robot process comprises the steps of:
providing a first time profile of a first state variable of the robot process for a first value of a first controller parameter of a controller for the robot process;
providing a further time profile, preferably a plurality of further time profiles, of the first state variable for (in each case) a different value of the first controller parameter;
for one or more of these provided time profiles, in each case ascertaining a quality value by means of data processing, preferably the same data processing, based at least in part on machine learning; and
optimizing the value of the first controller parameter by means of an optimizer on the basis of the values of the first controller parameter and the quality values ascertained for the time profiles for these values of the first controller parameter, wherein the values of the first controller parameter and, in each case, the associated or assigned quality value ascertained for the time profile for the particular value of the first controller parameter are preferably made available to the optimizer.

This is based on the idea of providing an optimizer, which in one embodiment can be a known and/or numerical optimizer, in one embodiment a gradient-based optimizer, an evolutionary optimizer, an optimizer based at least in part on machine learning, or the like, with quality criterion values for different values of a controller parameter, said values being ascertained by means of artificial intelligence.

As a result, in particular due to separate ascertainment of quality criterion values by means of data processing based at least in part on machine learning, which data processing is or has been trained thereon, parameterization of the controller can be improved, in particular can be carried out (more) quickly, with low(er) effort, (more) reliably, more consistently, and/or without experienced skilled personnel, and/or better controller parameters can be ascertained.

In one embodiment, the aforementioned time profiles provided for optimizing the value of the first controller parameter are time profiles of the first state variable of the robot process for (in each case) the same value of a second controller parameter of the controller and the different value(s) of the first controller parameter, and the method comprises the further steps of:
providing a second time profile of a second or, particularly preferably, the first state variable of the robot process for the optimized value of the first controller parameter and a first value of the second controller parameter of the controller;
providing a further time profile, preferably a plurality of further time profiles, of this first or second state variable for (in each case) a different value of the second controller parameter and the optimized value of the first controller parameter;
for one or more of these provided time profiles, in each case ascertaining a quality value by means of data processing, preferably the same data processing, based at least in part on machine learning, particularly preferably the (same) data processing by means of which the value of the first controller parameter has already been optimized or for which the quality values for the different values of the first controller parameter have been ascertained; and
optimizing the second controller parameter by means of an optimizer, particularly preferably the (same) optimizer by means of which the value of the first controller parameter has already been optimized, on the basis of the values of the second controller parameter and the quality values ascertained for the time profiles for these values of the second controller parameter, wherein the values of the second controller parameter and, in each case, the associated or assigned quality value ascertained for the time profile for the particular value of the second controller parameter are preferably made available to the optimizer.

This is based on the idea of optimizing the first controller parameter in two stages, so to speak with a constant second controller parameter, and then to optimize the second controller parameter with a constant, already optimized first controller parameter. In a further development, the first and the second controller parameter are controller parameters of a cascaded controller; in one embodiment, the first controller parameter is a controller parameter of an inner control loop (relative to the second controller parameter) and the second controller parameter is a controller parameter of an outer control loop (relative to the first controller parameter). In other words, in one embodiment, a cascaded controller is parameterized or optimized step by step, preferably from the inside outward (controller parameters).

As a result, the parameterization of the controller can be improved, in particular can be carried out (more) quickly, with low(er) effort, (more) reliably, and/or without experienced skilled personnel, and/or better controller parameters can be ascertained.

In one embodiment, the method comprises setting the controller on the basis of, with, or to the value of the first controller parameter ascertained or optimized by the optimizer, and, in a further development, on the basis of, with, or to the value of the second controller parameter ascertained or optimized by the optimizer.

In one embodiment, the first state variable comprises a first state quantity and one or more further state quantities of the robot process, wherein a time profile of the first state variable comprises a time profile of the first state quantity and a time profile of this/these further state quantity/quantities.

By using (a state variable having) two or more state quantities, the parameterization of the controller can be improved, in particular can be carried out (more) quickly and/or (more) reliably and/or better controller parameters can be ascertained.

In a further development, the first state quantity and the, or one or more of the, further state quantity or quantities are, in each case, different physical state quantities and, in one embodiment, comprise different physical dimensions.

Alternatively, or particularly preferably additionally, in a further development the first state quantity comprises a pose quantity, in particular a Cartesian position and/or orientation and/or drive position and/or joint position and/or a first and/or higher time derivative of a Cartesian position and/or orientation and/or drive position and/or joint position. In one embodiment of this further development, the, or one or more of the, further state quantity or values comprise, in each case, a load quantity, in particular a force and/or a torque and/or a first and/or higher time derivative of a force and/or a torque.

In a further development, the first state quantity comprises a load quantity, in particular a force and/or a torque and/or a first and/or higher time derivative of a force and/or a torque. In one embodiment of this further development, the, or one or more of the, further state quantity or values comprise, in each case, a position value, in particular a Cartesian position and/or orientation and/or drive position and/or joint position and/or a first and/or higher time derivative of a Cartesian position and/or orientation and/or joint position.

Alternatively, or particularly preferably additionally, in one embodiment the first and/or at least one further state quantity comprises (in each case) a difference between an actual value and a setpoint value, in particular a difference between an actual value and a setpoint value of a, preferably aforementioned, pose quantity or load quantity.

In one embodiment, the time profile of the first state variable comprises the time profile of the first state quantity and subsequently the time profile of at least one further state quantity, preferably the time profile of the first state quantity and the at least one further state quantity serially one after the other.

By means of one, or particularly preferably two or more, of these features, the parameterization of the controller can be improved, in particular can be carried out (more) quickly and/or (more) reliably and/or better controller parameters can be ascertained.

In one embodiment, providing the first time profile and the at least one further time profile of the first state variable for different values of the first controller parameter comprises performing the robot process in a real or simulated manner, changing the value of the first controller parameter during this performance, and dividing an overall time profile ascertained during this performance into the first and at least one further time profile. In a further development, providing the second time profile and the at least one further time profile for different values of the second controller parameter and, in each case, the optimized value of the first controller parameter comprises performing the robot process in a real or simulated manner, changing the value of the first controller parameter during this performance, and dividing an overall time profile ascertained during this performance into the first and this at least one further time profile.

As a result, the parameterization of the controller can be improved, in particular can be carried out (more) quickly, with low(er) effort, (more) reliably, and/or without experienced skilled personnel, and/or better controller parameters can be ascertained.

In one embodiment, providing the first time profile and the at least one further time profile of the first state variable for different values of the first controller parameter comprises scaling the first time profile and the at least one further time profile differently. In a further development, providing the second time profile and the at least one further time profile for different values of the second controller parameter and, in each case, the optimized value of the first controller parameter comprises scaling the second time profile and this at least one further time profile differently.

By means of one, or particularly preferably two or more, of these features, the parameterization of the controller can be improved, in particular can be carried out (more) quickly and/or (more) reliably and/or better controller parameters can be ascertained.

In one embodiment, the data processing, which is based at least in part on machine learning and by means of which the quality values used to optimize the value of the first controller parameter are ascertained for time profiles of the first state variable for the different values of the first controller parameter, and, in a further development, the quality values used to optimize the value of the second controller parameter are ascertained for time profiles of the state variable for the different values of the second controller parameter, comprises an artificial neural network and/or a decision tree algorithm and/or a random forest algorithm and/or, in a further development, is trained on the basis of a manual labeling of time profiles of the first state variable. In other words, an inventive method for parameterizing a controller for a robot process can use data processing that has already been trained accordingly and is based at least in part on machine learning, and, in a further development, can (also) comprise training on the basis of a manual labeling of time profiles of (at least) the first state variable itself. Manual labeling can comprise, in particular, evaluating different time profiles by a human operator who, advantageously on an empirical basis, assigns different quality values to the time profiles, in one embodiment on the basis of or taking into account the real or simulated performance of the robot process, for example by rating time profiles in which (greater) oscillations and/or control errors and/or process deviations and/or disturbances have occurred as poor(er), or the like.

By means of one, or particularly preferably two or more, of these features, the parameterization of the controller can be improved, in particular can be carried out (more) quickly and/or (more) reliably and/or better controller parameters can be ascertained.

In one embodiment, the robot process is a robot process having at least one robot arm and/or at least one robot-guided, preferably robot-arm-guided, tool, in particular a robot-guided welding gun, and/or the controller is a controller for controlling at least one robot (of the robot process), in particular at least one or the at least one robot arm and/or at least one or the at least one robot-guided tool, preferably the at least one robot-guided welding gun. In a further development, the controller is a controller for controlling at least one drive, in particular a motor, preferably an electric motor, at least one robot (of the robot process), preferably at least one or the at least one robot arm, and/or at least one robot-guided, in particular robot-arm-guided, tool, in one embodiment of a welding gun. Alternatively, or particularly preferably additionally, in one embodiment, the first controller parameter comprises a constant of a proportional and/or integral and/or differential controller, and may in particular be such a constant. In a further development, the second controller parameter can also comprise, in particular be, a constant of a proportional and/or integral and/or differential controller.

The present invention is particularly advantageous for these applications because of the process conditions.

According to one embodiment of the present invention, a method for performing a robot process or the robot process by means of a controller or the controller comprises the steps of:
parameterizing the controller according to a method described herein; and
performing the robot process by means of the parameterized controller.

According to one embodiment of the present invention, a system for parameterizing a controller or the controller for a robot process or the robot process, in particular in terms of hardware and/or software, in particular programming, is configured to carry out a method described herein and/or comprises:
means for providing a first time profile of a first state variable of the robot process for a first value of a first controller parameter of a controller for the robot process;
means for providing at least one further time profile of the first state variable for a different value of the first controller parameter;
means for ascertaining quality values for these provided time profiles by means of data processing based at least in part on machine learning, preferably the data processing based at least in part on machine learning, which, in one embodiment, comprise said data processing; and
means for optimizing the value of the first controller parameter by means of an optimizer on the basis of the values of the first controller parameter and the quality values ascertained for the time profiles for these values of the first controller parameter, preferably the optimizer.

A system and/or means within the meaning of the present invention may be designed as hardware and/or software, in particular may comprise at least one, in particular digital, processing unit, in particular microprocessor unit (CPU), graphics card (GPU), or the like, which is preferably data-connected or signal-connected to a memory system and/or bus system, and/or one or more programs or program modules, in particular one or more, preferably correspondingly programmed, computers. The processing unit may be designed to process commands that are implemented as a program stored in a memory system, to acquire input signals from a data bus and/or to deliver output signals to a data bus. A memory system may comprise one or more, in particular different, memory media, in particular optical, magnetic, solid-state, and/or other non-volatile media. The program can be designed in such a way that it embodies or is capable of executing the methods described herein, so that the processing unit can perform the steps of such methods and thus, in particular, optimize the value of the first controller parameter and, in a further development, of the second controller parameter; in a further development, parameterize the controller with this/these value(s); and, in one embodiment, perform the robot process by means of the parameterized controller. In one embodiment, a computer program product may comprise, in particular be, an, in particular computer-readable and/or non-volatile, memory medium for storing a program or instructions or with a program stored thereon or with instructions stored thereon. In one embodiment, execution of a said program or its instructions by a system or a control unit, in particular a computer or an arrangement of multiple computers, causes the system or the controller, in particular the computer(s), to execute a method described herein or one or more steps thereof, or the program or the instructions are configured to do so.

In one embodiment, one or more, in particular all, steps of the method are fully or partially computer-implemented or one or more, in particular all, steps of the method are fully or partially automated, in particular by the system or its means.

In one embodiment, the system comprises the robot(s), in particular the robot arm(s) and/or robot-guided tool(s), in particular welding gun(s), and/or the controller.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically illustrates a system for parameterizing a controller for a robot process for carrying out a method according to one embodiment of the present invention; and

FIG. 2 illustrates a method for parameterizing the controller according to one embodiment of the present invention.

### DETAILED DESCRIPTION

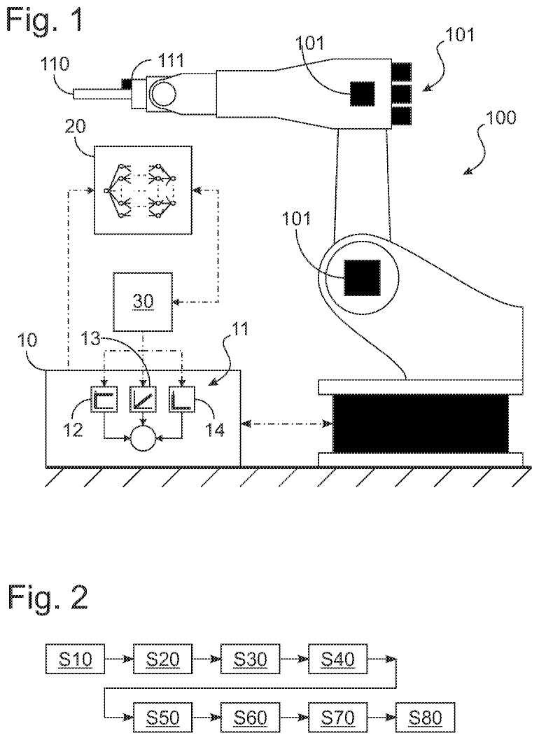

FIG. 1 depicts an exemplary system for parameterizing a controller 11 of a control unit 10 for controlling a robot arm 100 guiding a tool, preferably a welding gun 110. The controller 11 can in particular be a controller for controlling a drive 101 of the robot arm 100 or a drive 111 of the robot-guided tool 110.

In a step S10 (see FIG. 2), data processing 20 based at least in part on machine learning is first trained on the basis of a manual labeling of time profiles of a first state variable, which comprises, for example, position and torque following errors during a robot process with the welding gun 110. In this case, different processes are performed with varying process conditions and/or controller parameters, and a quality value is manually assigned to each of them, for example by rating processes having greater oscillations and/or process deviations and/or disturbances as poor(er), and the data processing 20 is trained in such a way that it assigns corresponding quality values to different time profiles.

In a step S20, the robot welding process is performed several times for different values of a proportional constant of a proportional component 12 and/or for different values of a differential constant of a differential component 14 and/or for different values of an integral constant of an integral component 13 of the controller, which may accordingly be a P controller, PI controller, PD controller or PID controller.

In a step S30, these data are processed, wherein in each case a time profile is provided for each value of the controller parameter(s), which value consists of the time profile of the position following error for this/these controller parameter value(s) and the subsequent or appended time profile of the torque following error for this/these controller parameter value(s).

In a step S40, an optimizer 30 first optimizes, for example, the proportional constant of the proportional component 12. For this purpose, for different values of the proportional constant, the optimizer receives the corresponding quality values that the data processing 20 ascertains for the time profile for the corresponding value of the proportional constant.

In a step S50, the optimizer 30 now optimizes, for example, the differential constant of the differential component 14 or the integral constant of the integral component 13 analogously, wherein the already optimized proportional constant is used. For this purpose, for different values of the differential constant or integral constant and the optimized proportional constant, the optimizer receives the corresponding quality values that the data processing 20 ascertains for the time profile for these controller parameter values.

With a PID controller, the third of the proportional, differential, and integral constants can then also be optimized analogously (step S60).

Subsequently, in a step S70, the controller 11 can be parameterized with these values, and in a step S80 the robot process can be performed with the controller parameterized in this way.

In the present disclosure, “comprises an X” generally does not imply an exhaustive list; rather, it is a short form of “comprises at least one X” and also covers “comprises two or more Xs” and “also comprises Y in addition to X.” Although exemplary embodiments have been described in the preceding description, it should be noted that a variety of modifications are possible. It should also be noted that the exemplary embodiments are merely examples and are not intended to restrict the scope of protection, the applications, or the structure in any way. Rather, the preceding description provides a person skilled in the art with guidelines for implementing at least one exemplary embodiment, with various changes, in particular with regard to the function and arrangement of the described components, being able to be made without departing from the scope of protection as defined by the claims and these equivalent combinations of features.

While the present invention has been illustrated by a description of various embodiments, and while these embodiments have been described in considerable detail, it is not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### List of Reference Signs

10 control unit
11 controller
12 proportional component
13 integral component

1-11. (canceled)

12. A method for parameterizing a controller for performing a robot process, comprising:
obtaining a first time profile of a first state variable of the robot process for a first value of a first controller parameter of the controller;
obtaining at least one further time profile of the first state variable for a different value of the first controller parameter;
determining quality values for the first and at least one further time profiles of the first state variable by data processing, wherein the data processing comprises at least one of assignment of predetermined values or data processing using machine learning; and
optimizing the value of the first controller parameter using an optimizer based on the values of the first controller parameter and the quality values determined for the first and at least one further time profiles for the corresponding values of the first controller parameter.

13. The method of claim 12, wherein:
the time profiles of the first state variable of the robot process, obtained for optimizing the value of the first controller parameter, are for the same value of a second controller parameter of the controller and different values of the first controller parameter; and
the method further comprises:
providing a second time profile of the first or a second state variable of the robot process for the optimized value of the first controller parameter and a first value of the second controller parameter,
providing at least one further time profile of the first or second state variable for the optimized value of the first controller parameter and a different value of the second controller parameter,
determining quality values for the second and at least one further time profiles of the first or second state variable by data processing using machine learning, and
optimizing the second controller parameter using an optimizer based on the values of the second controller parameter and the quality values determined for the first and at least one further time profiles for the corresponding values of the second controller parameter.

14. The method of claim 12, wherein:
the first state variable comprises a first state quantity and at least one further state quantity of the robot process; and
a time profile of the first state variable comprises a time profile of the first state quantity and a time profile of the at least one further state quantity.

15. The method of claim 14, wherein at least one of:
the first state quantity and the at least one further state quantity are different physical state quantities;
one of the first and the at least one further state quantity comprises a pose quantity or a load quantity;
at least one of the first or the at least one further state quantity comprises a difference between an actual value and a setpoint value; or
the time profile of the first state variable comprises the time profile of the first state quantity and subsequently the time profile of the at least one further state quantity.

16. The method of claim 12, wherein obtaining the first time profile and the at least one further time profile of the first state variable for different values of the first controller parameter comprises:
performing the robot process in a real or simulated manner;
changing the value of the first controller parameter during the performance of the robot process; and
dividing an overall time profile determined during the performance of the robot process into the first and at least one further time profile.

17. The method of claim 12, wherein providing the first time profile and the at least one further time profile of the first state variable for different values of the first controller parameter comprises scaling the first time profile and the at least one further time profile differently.

18. The method of claim 12, wherein the data processing using machine learning comprises at least one of:
an artificial neural network;
a decision tree algorithm;
a random forest algorithm; or
is trained based on a manual labeling of time profiles of the first state variable.

19. The method of claim 12, wherein at least one of:
the robot process is a robot process having at least one robot arm and/or at least one robot-guided tool;
the controller is a controller for controlling at least one of:
at least one robot,
at least one robot-guided tool,
at least one drive of a robot, or
at least one drive of a robot-guided tool; or
the first controller parameter comprises a constant of at least one of a proportional controller, and integral controller, or a differential controller.

20. A method of operating a robot with a controller to perform a robot process, the method comprising:
parameterizing the controller according to the method of claim 12; and
operating the robot with the parameterized controller to perform the robot process.

21. A system for parameterizing a controller for performing a robot process, the system comprising:
means for obtaining a first time profile of a first state variable of the robot process for a first value of a first controller parameter of the controller;
means for obtaining at least one further time profile of the first state variable for a different value of the first controller parameter;
means for determining quality values for the first and at least one further time profiles of the first state variable by data processing using machine learning; and
means for optimizing the value of the first controller parameter using an optimizer based on the values of the first controller parameter and the quality values determined for the first and at least one further time profiles for the corresponding values of the first controller parameter.

22. A computer program product comprising program code stored on a non-transitory, computer-readable storage medium, the program code, when executed on at least one computer, causing the at least one computer to carry out the method of claim 12.
